(19) United States
(12) Patent Application Publication
(10) Pub. No.: US 2023/0241832 A1
(43) Pub. Date: Aug. 3, 2023

(54) ABRASION AND DAMAGE RESISTANT FLEXIBLE HOSE

(71) Applicant: PARKER-HANNIFIN CORPORATION, cleveland, OH (US)

(72) Inventors: Rebecca L. RAMSAY, Newbury, OH (US); Gregory REARDON, Northfield, OH (US); Emily BRADSTREET, Kalamazoo, MI (US)

(21) Appl. No.: 18/002,007

(22) PCT Filed: May 13, 2021
(86) PCT No.: PCT/US2021/032281

§ 371 Date: Dec. 15, 2022

Related U.S. Application Data
(60) Provisional application No. 63/046,296, filed on Jun. 30, 2020.

(51) Int. Cl. B29C 53/58; F16L 11/08; B29K 311/10; B29L 23/00; B29K 105/08; B29K 105/10; B29K 305/00

(52) U.S. Cl. CPC B29C 53/582; F16L 11/087; B29C 53/587; B29K 2311/10; B29L 2023/005; B29K 2105/0827; B29K 2105/103; B29K 2305/00

(57) ABSTRACT

Disclosed herein are abrasion resistant flexible hoses and methods for manufacturing such hose. The abrasion resistant elastomeric hose comprises an inner surface and an outer surface, and a abrasion resistant material embedded in the hose at a depth that imparts a three-dimensional pattern at the outer surface of the hose.

### CROSS-REFERENCE TO RELATED APPLICATIONS

This application claims priority from U.S. Application No. 63/046,296, filed Jun. 30, 2020, the disclosure of which is hereby incorporated by reference in its entirety.

### FIELD

The present disclosure relates to flexible hose having high abrasion and damage resistance properties and methods for producing such abrasion and damage resistant flexible hose.

### BACKGROUND

Hoses used in domestic, automotive, and commercial etc. environments are frequently in contact with abrasive materials and sharp objects that can damage the hose while being used. In particular, these abrasive materials and sharp objects damage to the hose in a way that leads to loss of hose covering, reinforcement exposure and eventual hose failure.

Conventional methods for preventing and minimizing damage involve abrasion resistant covers (rubber or thermoplastic), sleeves, external guards, and/or rerouting hoses to avoid external damage prone areas. Abrasion resistant covers are useful to prevent minor abrasion damage but do not provide adequate protection in harsh environments which routinely cause the loss or destruction of large portions of hose cover. Abrasion resistant covers also tend to limit flexibility of the hose, especially as the cover material increases in thickness. The use of relatively thick abrasion resistant covers also requires skiving of the hose before fittings can be applied.

Sleeves and guards are bulky and make use of the hose more difficult. Ease of hose routing, flexibility, and hose identification are all impacted to some extent by sleeves and guards. Sleeves and guards also add to product cost because they involve additional installation steps and material.

Rerouting of hoses to avoid contact with materials and objects likely to cause damage is often inconvenient or impossible, particularly in very harsh environments and is limited by equipment design. Rerouting also often adds to product cost because additional hose is necessary.

Another method for preventing hose damage involves the incorporation of a reinforcement material below the rubber cover of the hose. The location of these reinforcement materials beneath the cover does not protect the cover from abrasion and damage and once the cover is removed the reinforcement materials can be damaged making the hose unusable.

Thus, there remains a need for hoses that are resistant to abrasion and loss of hose cover material, resistance to foreign object damage, or other loss of hose covering material.

### SUMMARY OF THE INVENTION

This disclosure provides a convenient solution to the problems identified above. More specifically, this disclosure provides flexible hose having high abrasion resistance and methods for manufacturing such hose. The hose disclosed herein overcomes the drawbacks outlined above.

In one aspect, disclosed herein is an abrasion and damage resistant flexible hose comprising an inner surface and an outer surface, the abrasion resistant flexible hose comprising a flexible tube and a reinforcement material embedded in the flexible tube at a depth that imparts a three-dimensional pattern at the outer surface of the abrasion resistant flexible hose. Thus, the pattern comprises individual features, wherein the individual features independently have a height, a width, and a depth.

In another aspect, disclosed herein is a method of producing an abrasion resistant flexible hose comprising
providing an uncured flexible tube having an inner surface and an outer surface;
applying an abrasion resistant material onto the outer surface of the uncured flexible tube; and
curing the uncured flexible tube such that the abrasion resistant material embeds into the flexible tube to a depth that imparts a three-dimensional pattern at the outer surface of the flexible tube.

In another aspect, disclosed herein is a method of producing abrasion resistant hose comprising
providing an uncured flexible tube having an inner surface and an outer surface;
applying an abrasion resistant material to the outer surface of the uncured flexible tube; and
embedding the abrasion resistant material into the outer surface of the flexible tube by curing the uncured flexible tube having the abrasion resistant material applied thereon.

Embedding abrasion resistant material into uncured flexible tube that will become the outer covering of the final hose according to this disclosure and subsequently curing the tube produces an abrasion resistant hose, e.g., a hose, that prevents or minimizes large portions of the hose cover from being removed by contact with abrasive materials or sharp objects. Abrasion resistant material embedded in flexible hose as described herein produces hose with increased resistance to abrasion compared to conventional approaches for producing abrasion resistant hose covers, particularly compared to covers having approximately the same thickness.

As disclosed herein, the abrasion resistant material is an integral component added to the outer cover component of the flexible tube. The abrasion resistant material is not added after curing the hose, as is the case with conventional sleeves or guards. Incorporating the abrasion resistant material into the cover material during the curing process is an efficient solution to the problems described above. The products and processes described herein eliminate the need for post-production handling and the additional costs required for sleeves and guards.

Abrasion resistant flexible hose manufactured according to this disclosure has inner and outer dimensions that are substantially the same as flexible hose produced without the embedded abrasion resistant material. The abrasion resistant flexible hose described herein also has a degree of flexibility similar to conventional abrasion resistant and non-abrasion resistant hose and may therefore be conveniently used wherever conventional hose is used.

The abrasion resistant hose disclosed herein can be manufactured to a desired degree of flexibility. Thus, these products made using the hose disclosed herein have high abrasion resistance and can be used in a wide variety of areas where they will come into contact with rough or sharp materials. The abrasion resistant hose disclosed herein demonstrates improved resistance to abrasion compared with hose made using conventional technology.

Because the abrasion resistant material is an integral component of the abrasion resistant flexible hose, hoses and hose assemblies, and other products can be manufactured from the abrasion resistant flexible hose with no special handling or skiving. The abrasion resistant flexible hose of this disclosure can be conveniently fitted with coupling mechanisms for a variety of uses.

### BRIEF DESCRIPTION OF THE DRAWINGS

FIG. 1 is a photograph of a conventional reinforced hose.

FIG. 2 is a cross-sectional diagram of an abrasion resistant flexible hose according to this disclosure.

FIG. 3 is a photograph of a fabric abrasion resistant material.

FIG. 4 is a photograph showing a representative process for manufacturing an abrasion resistant flexible hose according to this disclosure.

FIG. 5 is a photograph of a cured abrasion resistant flexible hose according to this disclosure.

FIG. 6 is a semi-exploded diagram of a conventional hose and a flexible abrasion resistant hose according to this disclosure.

FIG. 7 is a cross-sectional diagram of a abrasion resistant elastomeric sheet according to this disclosure.

FIG. 8 is a cross-sectional diagram of a abrasion resistant elastomeric sheet according to this disclosure.

FIG. 9 is a cross-sectional diagram showing the abrasion resistant material forming peaks and valleys in the outer surface of the flexible hose of this disclosure.

### DETAILED DESCRIPTION

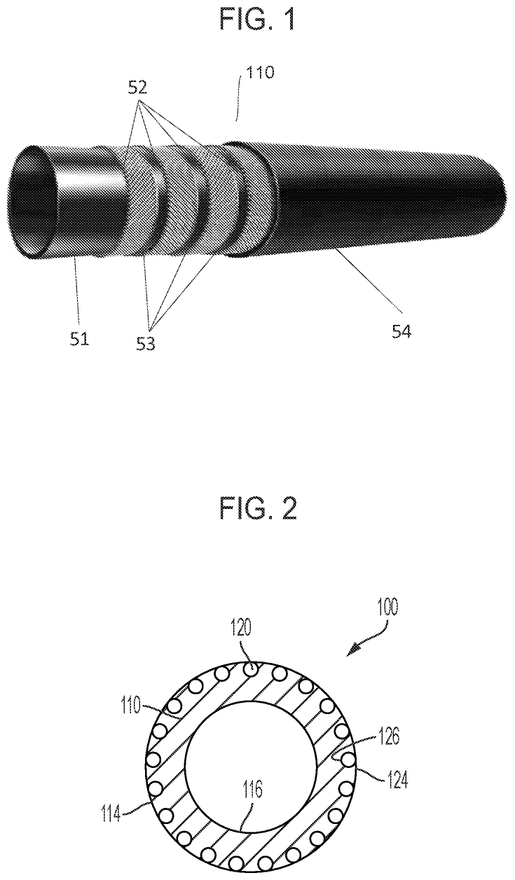

An example of prior art hoses that are suitable for use with the present invention is shown in FIG. 1 and referred to generically as flexible tube 110. The flexible tube 110 comprises an inner tube 51 which may be surrounded by one or more alternating layers of reinforcement material 52 and layerstock 53. The reinforcement material 52 increases the pressure resistance of the hose. The flexible tube 110 also comprises a cover 54 forming the exterior of the flexible tube 110. During manufacture, one or more layerstock or plies 53 and/or one or more layers of reinforcement material 52 may be applied to inner tube 51 carried on a mandrel. To this assembly is then applied the cover 54 or if there are no layerstock 53 and reinforcement material 52, the cover 54 is applied directly to the inner tube 51 which forms the flexible tube 110. Reinforcement material 52 is typically a braid of steel per FIG. 1 or it may be textile fiber or any known appropriate reinforcement material used for flexible hose. The tube 51, layerstock 53 and cover 54 are typically a flexible material such as rubber or other elastomeric material, but may be any known appropriate material used for flexible hose. Such known materials may be elastomers and thermoplastics, and more particularly NBR (Nitrile Butadiene Rubber), CPE (Chlorinated Polyethylene), EPDM (Ethylele propylene diene monomer), PVC (Polyvinyl Chloride), CR (Chloroprene Rubber), SBR (Styrene Butadiene Rubber), CIIR (Chlorobutyl), BIIR (Bromobutyl), HNBR (Hydrogenated Nitrile Butadiene Rubber), BR (Polybutadiene), NR (Natural), CSM (Chloro Sulfonated), FKM (fluoroelastomer), NBR/PVC, AEM (Ethylene Acrylate), Silicone Rubber, Polyurethanes (TPU), Polyamides including alloys and polyamide blends, Thermoplastic Copolyester, Thermoplastic Vulcanizate (TPV), Tetrafluoroethylene/Hexafluoropropylene (THV), Polyvinylidene Fluoride (PVDF), Polyether block amide (PEBA), Polyketones and combinations thereof.

Referring now generally to FIGS. 2-9, the present disclosure is of an abrasion resistant and damage resistant hose 100 (hereinafter referred to solely as abrasion resistant hose 100) and method of producing an abrasion resistant hose 100. Referring particularly to FIG. 2, the abrasion resistant hose 100 of present invention is shown in cross-section in FIG. 2 having an inner surface 116 and an outer surface 114. Abrasion resistant hose 100 comprises an abrasion resistant material 120 embedded into the flexible tube 110. The abrasion resistant material 120 may be embedded at any appropriate depth to provide protection to the hose 100. The abrasion resistant material 120 embeds in the flexible tube 110 when the hose 100 is cured as discussed in detail below.

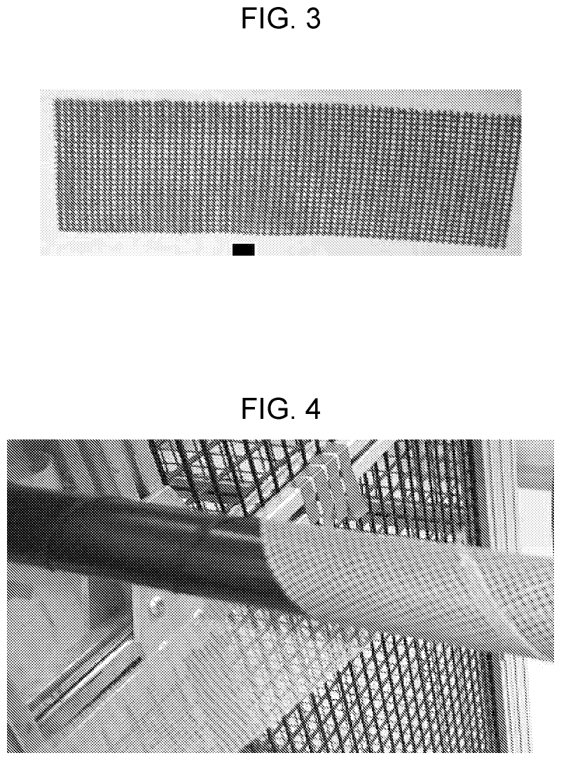

The abrasion resistant material 120 may be any material that can protect the flexible tube 110 from abrasion and damage and that can embed into the flexible tube 110 during the curing process. In certain embodiments, the abrasion resistant material 120 is a mesh comprising an arrangement of interconnected wires or threads, and the wires and threads comprise metal, naturally-occurring material, or synthetic material, or a combination thereof. Examples of appropriate metals include, but are not limited to, aluminum, steel or stainless steel. Examples of naturally-occurring materials include, but are not limited to, silk, wool or cotton such as the fabric shown in FIG. 3. Examples of suitable synthetic polymers include, but are not limited to, polyamides, polyvinylidene fluorides, polyethylenes, polyesters, polypropylenes, polyaramides (e.g., Kevlar), and carbon fiber. The reinforcement material 120 may also be a polyimide, rayon, acrylic, polyurethane, polyether-polyurea, polystryrene, polytetrafluoroethylene (teflon), or polyvinylchloride. The reinforcement material 120 may also be a combination of one or more of the materials listed in this paragraph.

The wires and threads useful as the reinforcement material may be any of a variety of cross-sectional shapes or combinations thereof. These may be round, oval, rectangular (including square), triangular, etc. The thickness of the wires and threads is selected for the desired degrees of flexibility and abrasion resistance. The material thickness will also be a function of the strength of the material. Thus, polyaramid materials of lesser thickness fibers compared to cotton threads may be used.

Suitable mesh material for use herein has openings selected according to the desired end use and the degree of abrasion resistance necessary as well as the diameter size of the hose. Mesh opening diameter is measured at the largest dimension, i.e., the diameter of a rectangular opening would be measured corner to opposite corner. In certain embodiments, the mesh openings have average diameters of from about 1 mm to about 50 mm. In other embodiments, the mesh openings have average diameters of from about 5 mm to about 50 mm, or about 10 mm to about 50 mm, or about 15 mm to about 50 mm, or about 20 mm to about 50 mm, or about 25 mm to about 50 mm, or about 30 mm to about 50 mm, or about 40 mm to about 50 mm, or about 1 mm to about 40 mm, or about 1 mm to about 30 mm, or about 1 mm to about 20 mm, or about 1 mm to about 15 mm, or about 1 mm to about 10 mm, or about 1 mm to about 7.5 mm, or about 1 mm to about 5 mm, or about 1 mm to about 2 mm, or about 1 mm to about 3 mm.

In certain alternatively aspects, the abrasion resistant material 120 is embedded in the hose at a depth that does not impart a three-dimensional pattern at the outer surface of the hose but is still sufficiently near the surface of the hose to achieve the desired improved resistance to abrasion and cutting. In these aspects, the abrasion resistant material 120 is embedded in the flexible hose at a depth, i.e., the distance between the mesh face 124 and hose outer surface 114, of about 0.05 mm to 5 mm, about 0.05 mm to 4 mm, about 0.05 mm to 3 mm, about 0.05 mm to 2, mm. about 0.05 mm to 1 mm, about 0.1 mm to 5 mm, about 0.2 mm to 5 mm, about 0.3 mm to 5 mm, about 0.4 mm to 5 mm, about 0.5 mm to 5 mm, about 0.75 mm to 5 mm, about 1 mm to 5 mm, about 2 mm to 5 mm, about 3 mm to 5 mm, or about 4 mm to 5 mm beneath the external surface of the hose.

FIG. 4 shows application of abrasion resistant material 120, here a fabric, to uncured flexible hose 110. In this particular embodiment, application of the abrasion resistant material is accomplished by spirally winding the abrasion resistant material, around the hose with a small amount of abrasion resistant material overlap.

During manufacture, the uncured flexible hose 110 can conveniently be supported by a mandrel (not shown), i.e., a cylindrical rod made of metal or suitable polymer, that may be rotated as necessary. Alternatively, the abrasion resistant fabric 120 may be applied in a braided fashion. In another alternative, the abrasion resistant material 120 can be applied longitudinally (i.e., cigarette style).

The abrasion resistant material 120 is wrapped or otherwise applied to the uncured flexible hose 110 in a manner that will ensure that the abrasion resistant material 120 remains positioned around the uncured flexible hose 110 until the curing process is initiated. During the curing process, the flexible hose softens and the abrasion resistant material embeds into the outer surface of the flexible hose 110. After cure, the abrasion resistant material 120 remains embedded in the flexible tube 110.

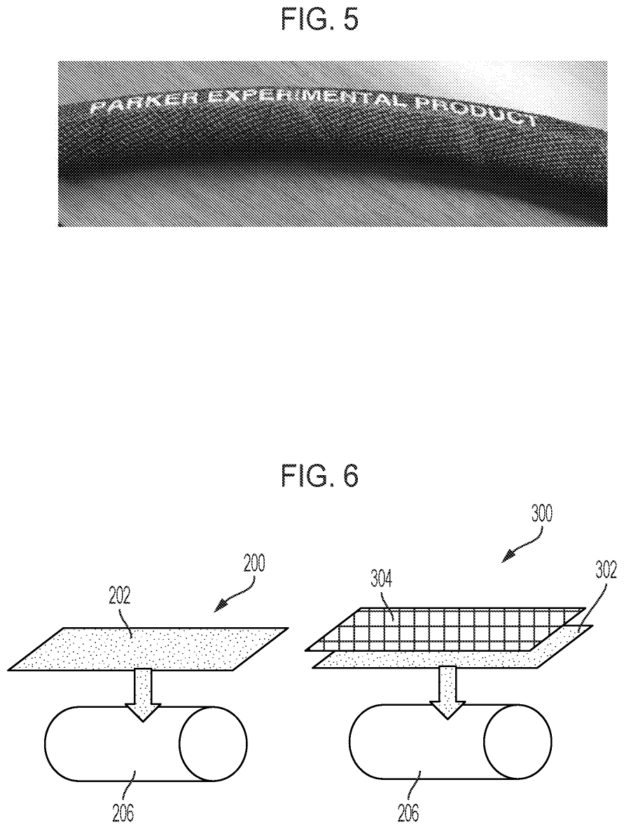

In certain embodiments, prior to curing, a wrap tape (e.g., woven nylon) or a sheath of polymer is applied over the abrasion resistant material 120 to hold all the components in place during the cure process. After curing, the mandrel and the wrap tape or polymer sheath is removed. FIG. 5 shows a completed and cured abrasion resistant flexible hose as disclosed herein. The particular hose shown comprises rubber as the elastomer.

FIG. 6 shows an exploded diagram comparison of a conventional hose 200 and an abrasion resistant hose 300 according to this disclosure. Conventional hose 200 contains only a cover material 202 applied to a core material 206. The core may contain multiple layers or plies of flexible hose and/or reinforcement. Abrasion resistant hose 300 includes an abrasion resistant material 304, i.e., a mesh or fabric, applied to and embedded into flexible hose 302 which covers a core. The core may contain multiple layers or plies of flexible hose and/or reinforcement.

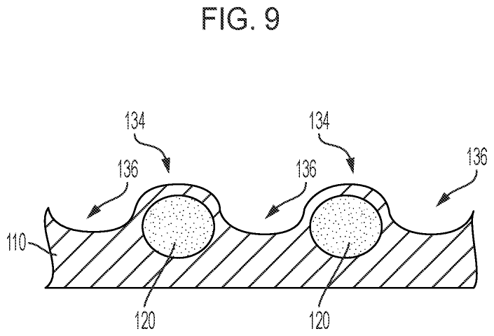

In certain aspects of the abrasion resistant hose 100 disclosed herein, the abrasion resistant material 120 is a mesh or a fabric. As shown in FIG. 9, in aspects of the disclosure where the fabric and mesh materials 120 are embedded to a depth that produces a three-dimensional pattern in surface 114 of the hose 100 portions of the mesh or fabric 120 forms a peak 134 and the adjacent area lacking mesh or fabric is a valley 136 with respect to peak 134. The height of each peak 134 with respect to each valley 136 is a measurable dimension. In contrast, the configuration shown in FIG. 2 shows the abrasion resistant material 120 flush with the outer surface 114 of the hose 100.

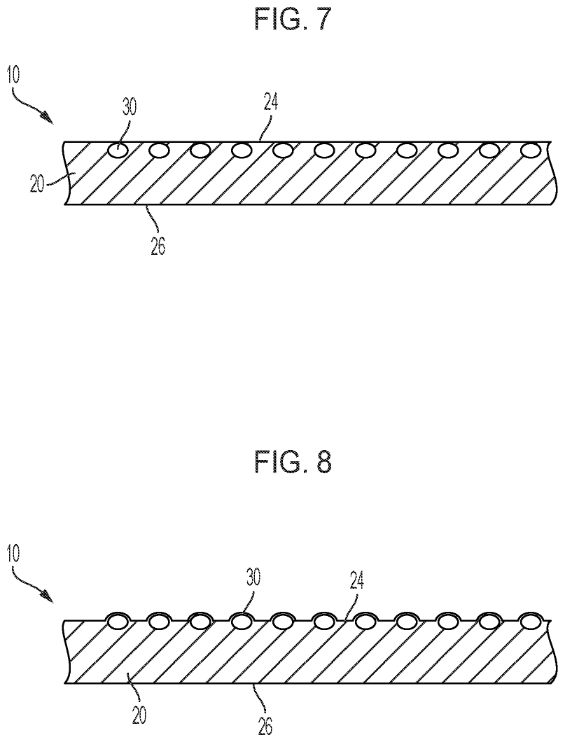

FIGS. 7 and 8 are drawings of alternative configurations of the present invention. The assembly shown in FIG. 7 is a abrasion resistant flexible sheet 10 comprising a layer of flexible material 20 and abrasion resistant material 30. In FIG. 7, abrasion resistant material 30 is substantially flush with upper surface 24 of flexible material 20. Similarly, the assembly shown in FIG. 8 is a abrasion resistant flexible sheet 10 comprising a layer of flexible hose 20 and abrasion resistant material 30. In FIG. 8, however, the abrasion resistant material mesh 30 protrudes slightly above the flexible material 20. In each of FIGS. 7 and 8, the abrasion resistant material 30 may be uncovered or may be covered by a thin layer of flexible material 20.

Having described the abrasion resistant hose and method for making the abrasion resistant hose in detail and by reference to specific examples thereof, it will be apparent that modifications and variations are possible without departing from the scope of what is defined in the appended claims. More specifically, although some aspects of the present disclosure are identified herein as particularly advantageous, it is contemplated that the present disclosure is not necessarily limited to these particular aspects of the disclosure.

1. A method of producing an abrasion resistant flexible hose comprising
providing an uncured flexible tube having an inner surface and an outer surface;
applying an abrasion resistant material to the outer surface of the uncured flexible tube; and
curing the uncured flexible tube such that the abrasion material embeds into the flexible tube to a depth that imparts a three-dimensional pattern at the outer surface of the flexible tube; or
embedding the abrasion resistant material into the outer surface of the uncured flexible tube by curing the uncured flexible tube having the first abrasion resistant material applied thereon.

2. (canceled)

3. A method according to claim 1, wherein the abrasion resistant material is a mesh comprising an arrangement of interconnected wires or threads, and the wires and threads comprise metal, naturally-occurring material, or synthetic material, or a combination thereof.

4. A method according to claim 1, wherein the uncured flexible tube is directly or indirectly supported by a mandrel.

5. A method according to claim 1, wherein the uncured flexible tube comprises an inner tube of uncured material surrounded by one or more plies of uncured material and/or one or more reinforcement layers.

6. A method according to claim 1, wherein the uncured flexible hose includes a cover layer which forms the outer surface of the uncured flexible hose.

7. An abrasion resistant flexible hose comprising an inner surface and an outer surface, the hose comprising a flexible tube and an abrasion resistant material embedded in the outer surface of the flexible tube at a depth that imparts a three-dimensional pattern at the outer surface of the flexible tube.

8. An abrasion resistant flexible hose according to claim 7, wherein the abrasion resistant material is a mesh comprising an arrangement of interconnected wires or threads, and the wires and threads comprise metal, naturally-occurring material, or synthetic material, or a combination thereof.

9. (canceled)

10. An abrasion resistant flexible hose according to claim 7, wherein the mesh has openings having average diameters of from about 1 mm to about 5 mm.

11. An abrasion resistant flexible hose according to claim 7, wherein the wires and threads have a thickness of from 0.01 mm to about 2 mm.

12. An abrasion resistant flexible hose according to claim 7, wherein the wires and threads comprise metal.

13. An abrasion resistant flexible hose according to claim 7, wherein the wires and threads comprise steel, stainless steel or aluminum.

14. An abrasion resistant flexible hose according to claim 7, wherein the wires and threads comprise a naturally occurring polymer.

15. An abrasion resistant flexible hose according to claim 7, wherein the wires and threads comprise a synthetic polymer.

16. An abrasion resistant flexible hose according to claim 7, wherein the mesh is made from a material selected from the group consisting of polyamide, polyvinylidene fluoride, polyethylene, polyester, polypropylene, stainless steel, steel, aramid, carbon fiber, and mixtures thereof.

17. An abrasion resistant flexible hose according to claim 7, wherein the flexible hose comprises an elastomer.

18. An abrasion resistant flexible hose according to claim 7, wherein the flexible hose comprises a thermoplastic.

19. (canceled)

20. (canceled)

21. (canceled)

22. An abrasion resistant flexible hose according to claim 7, further comprising at least one reinforcing layer within the inner tube.

23. An abrasion resistant flexible hose comprising a flexible tube, wherein the flexible tube has an outer surface and an inner surface, and a mesh abrasion resistant material embedded in the outer surface of the flexible tube, wherein the mesh has a face and a back, wherein the distance between the mesh face and the upper surface of the flexible hose is less than the distance from the mesh back to the inner surface of the flexible tube.

24. A method of producing an abrasion resistant flexible hose according to claim 7, the method comprising embedding a mesh into an a flexible tube to a depth that imparts a three-dimensional pattern at the outer surface of the tube.

25. An abrasion resistant flexible hose according to claim 7, wherein the pattern comprises individual features, wherein the individual features independently have a height, a width, and a depth.
